(19) United States
(12) Patent Application Publication
(10) Pub. No.: US 2022/0311287 A1
(43) Pub. Date: Sep. 29, 2022

(54) WIRELESS POWER TRANSMISSION APPARATUS

(71) Applicant: NINGBO WEIE ELECTRONICS TECHNOLOGY LTD., Ningbo (CN)

(72) Inventors: Cong Yin, Ningbo (CN); Ang Ma, Ningbo (CN); Feng Yu, Ningbo (CN); Weiyi Feng, Ningbo (CN)

(73) Assignee: NINGBO WEIE ELECTRONICS TECHNOLOGY LTD., Ningbo (CN)

(21) Appl. No.: 17/682,142

(22) Filed: Feb. 28, 2022

(30) Foreign Application Priority Data
Mar. 23, 2021 (CN) 202110310172.9

(51) Int. Cl. H02J 50/90; H02J 50/10; H02J 50/00

(52) U.S. Cl. CPC H02J 50/90; H02J 50/10; H02J 50/005

(57) ABSTRACT

Disclosed in an embodiment of the present disclosure is a wireless power transmission apparatus, including a coil, accommodation bodies, and magnet units, wherein the accommodation bodies are arranged at intervals around the coil; and the magnet unit is disposed in the accommodation body in a movable manner. Owing to a constrained activity of the magnet unit, the wireless power transmission apparatus in the technical solution of the embodiment of the present disclosure can adapt to a plurality of wireless power receiving or transmitting apparatuses, thereby having good practicability, and improving the use experience of a user and the charging efficiency.

### CLAIM OF PRIORITY AND CROSS-REFERENCE TO RELATED APPLICATION

This application claims the benefit of Chinese Patent Application No. 202110310172.9, filed on Mar. 23, 2021, entitled “Wireless Power Transmission Apparatus”, which is incorporated herein by reference in its entirety.

### BACKGROUND OF THE INVENTION

### 1. Field of the Invention

The present disclosure relates to the field of wireless charging devices, and more particularly to a wireless power transmission apparatus.

### 2. Description of the Related Art

With the sustainable development of portable mobile communication devices, the wireless charging function is applied more and more widely. The premise of providing good experience is that center of a receiving coil of a wireless charging apparatus aligns with center of a transmitting coil thereof. In an existing technical solution, wireless charging devices mostly do not have an alignment assistance function, and those having the alignment assistance function can only adapt to a specific device model, or magnet unit equipped therefor can only be used in cooperation with one of a wireless power receiving device and a wireless power transmitting device, but is mutually exclusive with the other one.

Therefore, when a user charges a mobile communication device, the user can only rely on intuition and experience to estimate center positions of the receiving coil and the transmitting coil hidden therein according to the shape of the device, thereby consuming more time and attention, and having poor experience. Due to the position offset of the receiving coil and the transmitting coil, the actual wireless charging power cannot reach a design power; therefore, the device has a reduced charging efficiency and a serious heating problem.

### BRIEF DESCRIPTION OF THE INVENTION

In view of the existing status, an embodiment of the present disclosure provides a wireless power transmission apparatus which has good adaptability, strong availability, and high charging efficiency.

The wireless power transmission apparatus of the embodiment of the present disclosure includes:

a coil;

accommodation bodies, arranged at intervals around the coil; and

magnet units, disposed in the accommodation body in a movable manner.

In some embodiments, the magnet unit is disposed to be movable in a first direction in the accommodation body, the first direction being in parallel with the axial direction of the coil.

In some embodiments, the dimension of the accommodation body in the first direction is greater than the dimension of the magnet unit in the first direction.

In some embodiments, the wireless power transmission apparatus is provided with an acting surface; surface of the accommodation body distal from the acting surface is lower than surface of the coil distal from the acting surface.

In some embodiments, the magnet unit is disposed to be slidable or rollable in a second direction in the accommodation body, the second direction being perpendicular to the axial direction of the coil.

In some embodiments, the dimension of the accommodation body in the second direction is greater than the dimension of the magnet unit in the second direction.

In some embodiments, the wireless power transmission apparatus is provided with an acting surface;

surface of the magnet unit in proximity to the acting surface is a first magnetic pole; or

one end close to the coil and on the surface of the magnet unit in proximity to the acting surface is a first magnetic pole, the other end distal from the coil is a second magnetic pole; or

one end close to the coil and on the surface of the magnet unit in proximity to the acting surface and the other end distal from the coil are first magnetic poles, and a second magnetic pole is disposed between the two first magnetic poles; and

the first magnetic pole and the second magnetic pole have opposite polarities.

In some embodiments, the magnet unit has a rollable shape; the magnet unit is divided into two sides by a surface passing the center of the magnet unit; one side is a first magnetic pole, and the other side is a second magnetic pole; and

the first magnetic pole and the second magnetic pole have opposite polarities.

In some embodiments, the accommodation body is formed as a box; or

the accommodation body is formed as a fence.

In some embodiments, the accommodation body accommodates at least one magnet unit.

In some embodiments, the accommodation body accommodates multiple magnet units, and ends of the magnet units in proximity to the coil have the same magnetic polarity.

The wireless power transmission apparatus of the embodiment of the present disclosure includes a coil, accommodation bodies, and magnet units, wherein the accommodation bodies are arranged at intervals around the coil; and the magnet unit is disposed in the accommodation body in a movable manner. Owing to a constrained activity of the magnet unit, the wireless power transmission apparatus in the technical solution of the embodiment of the present disclosure can adapt to a plurality of wireless power receiving or transmitting apparatuses, thereby having good practicability, and improving the use experience of a user and the charging efficiency.

### BRIEF DESCRIPTION OF THE DRAWINGS

Through the following description of the embodiments of the present disclosure with reference to the drawings, the above and other objectives, features and advantages of the embodiment of the present disclosure will become more apparent, wherein

FIG. 1 is a structural schematic view of a first wireless power receiving apparatus and a second wireless power receiving apparatus;

FIG. 2 is a structural schematic view of a first wireless power transmitting apparatus and a second wireless power transmitting apparatus;

FIG. 3 is a structural schematic view of a wireless power transmission apparatus according to a first embodiment of the present disclosure;

FIG. 4 is an operating schematic view of the wireless power transmission apparatus according to the first embodiment of the present disclosure;

FIG. 5 is an operating schematic view of the wireless power transmission apparatus in cooperation with the first wireless power receiving apparatus according to a second embodiment of the present disclosure;

FIG. 6 is an operating schematic view of the wireless power transmission apparatus in cooperation with the first wireless power transmitting apparatus according to the second embodiment of the present disclosure;

FIG. 7 is an operating schematic view of the wireless power transmission apparatus in cooperation with the first wireless power receiving apparatus according to a third embodiment of the present disclosure;

FIG. 8 is an operating schematic view of the wireless power transmission apparatus in cooperation with the first wireless power transmitting apparatus according to the third embodiment of the present disclosure;

FIG. 9 is an operating schematic view of the wireless power transmission apparatus in cooperation with the first wireless power receiving apparatus according to a fourth embodiment of the present disclosure;

FIG. 10 is an operating schematic view of the wireless power transmission apparatus in cooperation with the first wireless power transmitting apparatus according to the fourth embodiment of the present disclosure;

FIG. 11 is an operating schematic view of the wireless power transmission apparatus in cooperation with the second wireless power receiving apparatus according to the fourth embodiment of the present disclosure;

FIG. 12 is an operating schematic view of the wireless power transmission apparatus in cooperation with the second wireless power transmitting apparatus according to the fourth embodiment of the present disclosure;

FIG. 13 is an operating schematic view of the wireless power transmission apparatus in cooperation with the first wireless power receiving apparatus according to a fifth embodiment of the present disclosure;

FIG. 14 is an operating schematic view of the wireless power transmission apparatus in cooperation with the first wireless power transmitting apparatus according to the fifth embodiment of the present disclosure;

FIG. 15 is an operating schematic view of the wireless power transmission apparatus in cooperation with the second wireless power receiving apparatus according to the fifth embodiment of the present disclosure;

FIG. 16 is an operating schematic view of the wireless power transmission apparatus in cooperation with the second wireless power transmitting apparatus according to the fifth embodiment of the present disclosure;

FIG. 17 is an operating schematic view of the wireless power transmission apparatus in cooperation with the first wireless power receiving apparatus according to a sixth embodiment of the present disclosure; and

FIG. 18 is an operating schematic view of the wireless power transmission apparatus in cooperation with the first wireless power transmitting apparatus according to a seventh embodiment of the present disclosure.

### DESCRIPTION OF REFERENCE SIGNS

A0, acting surface; A1, first embodiment of the wireless power transmission apparatus of the present disclosure; A2, second embodiment of the wireless power transmission apparatus of the present disclosure; A3, third embodiment of the wireless power transmission apparatus of the present disclosure; A4, fourth embodiment of the wireless power transmission apparatus of the present disclosure; A5, fifth embodiment of the wireless power transmission apparatus of the present disclosure; A6, sixth embodiment of the wireless power transmission apparatus of the present disclosure; A7, seventh embodiment of the wireless power transmission apparatus of the present disclosure; B0, receiving surface; B1, first wireless power receiving apparatus; B2, second wireless power receiving apparatus; C0, transmitting surface; C1, first wireless power transmitting apparatus; and C2, second wireless power transmitting apparatus.
1, coil; 2, magnet unit; 20, accommodation body; 21, first magnetic pole; 22, second magnetic pole; 23, un-magnetized region; 3, wireless power receiving coil; 4, magnet unit of the wireless power receiving apparatus; 41, first magnetic pole of the magnet unit of the wireless power receiving apparatus; 42, second magnetic pole of the magnet unit of the wireless power receiving apparatus; 43, un-magnetized region of the magnet unit of the wireless power receiving apparatus; 5, wireless power transmitting coil; 6, magnet unit of the wireless power transmitting apparatus; 61, first magnetic pole of the magnet unit of the wireless power transmitting apparatus; 62, second magnetic pole of the magnet unit of the wireless power transmitting apparatus; and 63, un-magnetized region of the magnet unit of the wireless power transmitting apparatus.

### DETAILED DESCRIPTION OF EMBODIMENTS OF THE INVENTION

The present disclosure is described below on the basis of the embodiments, but is not merely limited to these embodiments. Specific details are described in detail in the following detailed description of the present disclosure. The present disclosure can also be fully understood by a person skilled in the art without the description of the details. In order to avoid confusing the essence of the present disclosure, commonly known method, process, flow, element and circuit are not described in detail.

In addition, a person skilled in the art should understand that the drawings herein are provided for the purpose of description only, and are not necessarily drawn in proportion.

Unless otherwise stated, the terms “comprise”, “include” and the like in the entire application document shall be interpreted as inclusive rather than exclusive or exhaustive; in other words, the terms mean “include but not limited to”.

In the descriptions of the present disclosure, it should be understood that the terms like “first”, “second” and the like are used for the purpose of description only, but cannot be considered to indicate or imply relative importance. In addition, in the descriptions of the present disclosure, unless otherwise stated, the meaning of “a plurality of” is two or more.

Unless otherwise stated or defined, the terms “install”, “connected”, “connect”, “fix” and the like should be understood in a broad sense, for example, the term “connected” may be fixedly connected or detachably connected or integrally connected, may be mechanically connected or electrically connected, may be directly connected or indirectly connected by means of an intermediate medium, and may be internally communicated or have an interaction relationship between two elements. A person skilled in the art can understand the specific meanings of the above terms in the present disclosure according to specific circumstances.

The technical solution of the present disclosure will be further described below with reference to the accompanying drawings and specific embodiments.

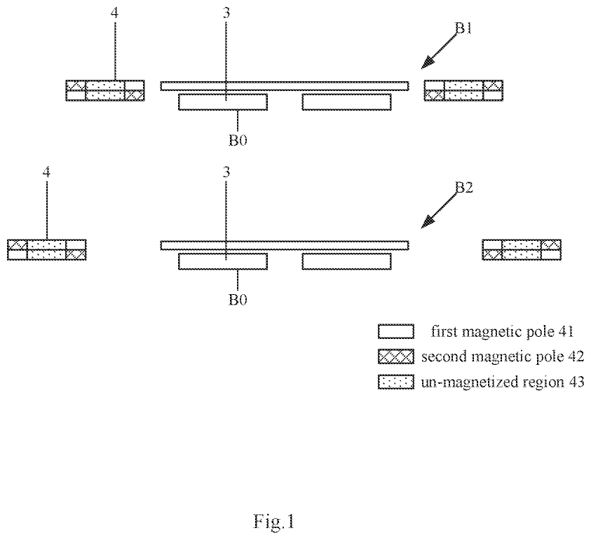

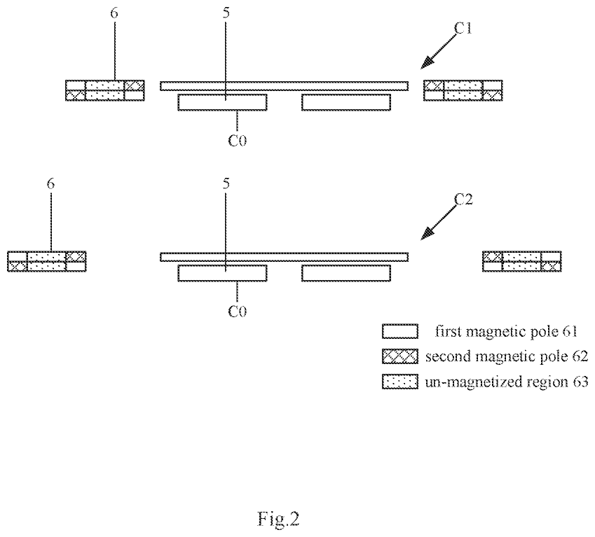

FIG. 1 is a structural schematic view of a first and a second wireless power receiving apparatuses. FIG. 2 is a structural schematic view of a first and a second wireless power transmitting apparatuses. As shown in FIGS. 1 and 2, in the prior art, wireless power is generally received and transmitted according to the electromagnetic induction principle; two coils are placed at adjacent positions; when current flows in one coil, generated magnetic flux becomes a medium, such that an electromotive force is generated in the other coil. Therefore, a wireless power device is one of a wireless power receiving apparatus and a wireless power transmitting apparatus.

The existing wireless power receiving apparatus and the wireless power transmitting apparatus may be provided with magnet units 4/6, so as to generate a magnetically positioning effect. Furthermore, the two apparatuses are used in cooperation with each other; the magnetic pole of the magnet unit 6 is generally configured to be opposite to the magnetic pole of the magnet unit 4. To facilitate description, in first and second wireless power receiving apparatuses B1, B2 and first and second wireless power transmitting apparatuses C1, C2, the magnet unit 4 and the magnet unit 6 are configured to be magnets having two ends with opposite polarities and an un-magnetized middle part, wherein the wireless power receiving apparatus is provided with a receiving surface B0, and the wireless power transmitting apparatus is provided with a transmitting surface C0. On one surface of the magnet unit 4 in proximity to the receiving surface B0, one end close to the wireless power receiving coil 3 is second magnetic pole 42, and the other distal end is first magnetic pole 41. On one surface of the magnet unit 6 in proximity to the transmitting surface C0, one end close to the wireless power transmitting coil 5 is first magnetic pole 61, and the other distal end is second magnetic pole 62, wherein the first magnetic pole 41/61 and the second magnetic pole 42/62 have opposite polarities. Un-magnetized region 43/63 is disposed between the two magnetic poles, and is magnetized to a certain extent by the magnetic poles on two sides due to the characteristic of the magnet. Optionally, the magnet unit 4 and the magnet unit 6 can also have other magnetic pole configurations.

In addition, to facilitate the description of the cooperation between the wireless power transmission apparatus in the embodiment of the present disclosure and different wireless power receiving or transmitting apparatuses, the magnet units 4/6 of the first wireless power receiving apparatus B1 and the first wireless power transmitting apparatus C1 are configured to have a certain gap between the wireless power receiving coil 3 or the wireless power transmitting coil 5; and the magnet units and the second wireless power receiving apparatus B2 or the second wireless power transmitting apparatus C2 have a different gap therebetween.

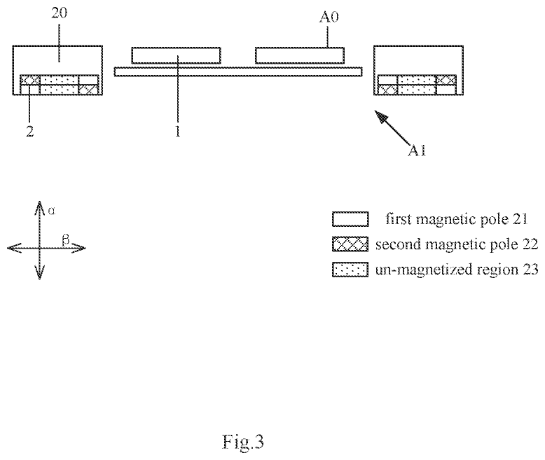

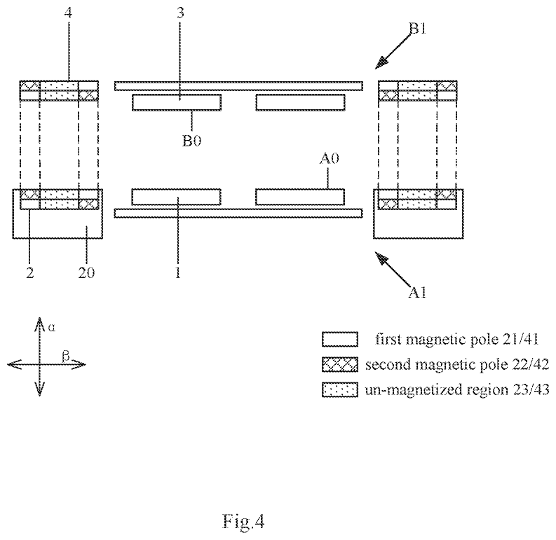

FIGS. 3 and 4 are respectively a structural schematic view and an operating schematic view of the wireless power transmission apparatus according to the first embodiment of the present disclosure. As shown in FIGS. 3 and 4, the wireless power transmission apparatus includes a coil 1, accommodation bodies 20, and magnet units 2, wherein the coil 1 is configured to receive or transmit power in a wireless manner; the accommodation bodies 20 are arranged at intervals around the coil 1; and the magnet unit 2 is disposed in the accommodation body 20 in a movable manner. In other words, the magnet unit 2 can move in the accommodation body 20 in a first direction and/or a second direction, wherein as shown in the figures, a is the first direction, f3 is the second direction, the first direction is in parallel with the axial direction of the coil 1, and the second direction is perpendicular to the axial direction of the coil 1.

In the present embodiment, namely in the wireless power transmission apparatus A1, the magnet unit 2 is disposed to be movable in a first direction α in the accommodation body 20.

The wireless power transmission apparatus A1 is provided with an acting surface A0, namely a surface capable of receiving or transmitting wireless power when in use. When used in cooperation with an external wireless power device, the magnet unit 2 rises in the accommodation body 20, and gets close to the acting surface A0, so as to reduce the distance between itself and the magnet unit of the external wireless power device, so that provide a stronger magnetic attraction force.

Further, one surface of the accommodation body 20 distal from the acting surface A0 should be lower than one surface of the coil 1 distal from the acting surface A0. In other words, in the first direction α in which the magnet unit 2 moves, the bottom surface of the accommodation body 20 is lower than the bottom surface of the coil 1. With the design, when the external wireless power device does not have a magnet unit, the magnet unit 2 is not attracted by the magnetic attraction force, but is closely attached to the bottom surface of the accommodation body 20 and holds still at the bottom of the accommodation body 20, so as to keep away from a wireless power transmission path of the coil 1, thereby improving the charging and discharging efficiency of the wireless power transmission apparatus A1.

In the present embodiment, the magnetic poles of the magnet unit 2 of the wireless power transmission apparatus A1 is configured in cooperation with the magnetic poles of the magnet unit of the external wireless power device. That is, one end close to the coil 1 and on the surface in proximity to the acting surface A0 of the magnet unit 2 is first magnetic pole 21, the other end distal from the coil 1 is second magnetic pole 22, and the middle part between the two magnetic poles is un-magnetized region 23. Optionally, the magnetic poles of the magnet unit 2 of the wireless power transmission apparatus can change, and the shape thereof can also change.

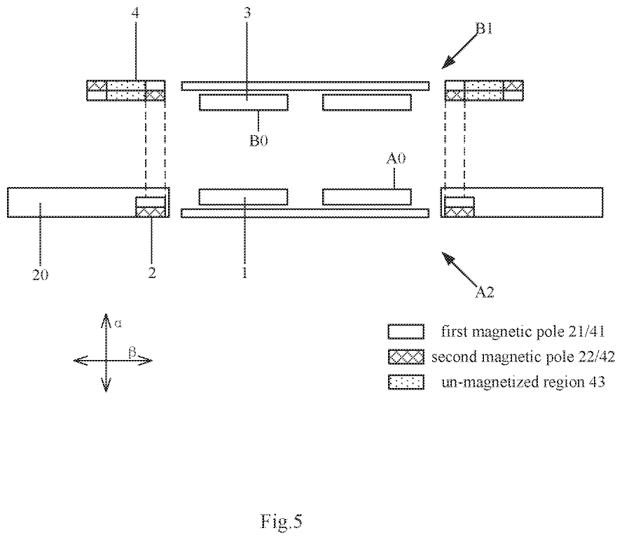

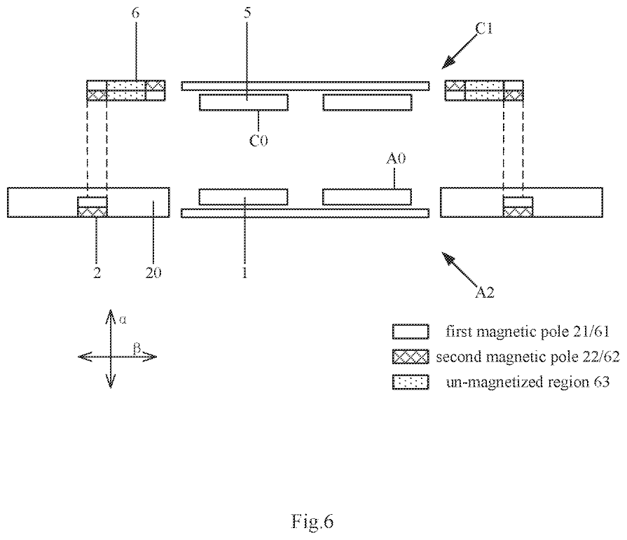

FIGS. 5 and 6 are operating schematic views of the wireless power transmission apparatus in cooperation with the first wireless power receiving apparatus and the first wireless power transmitting apparatus according to the second embodiment of the present disclosure. As shown in FIGS. 5 and 6, in the present embodiment, namely in the wireless power transmission apparatus A2, the magnet unit 2 is disposed to be slidable in a second direction (3 in the accommodation body 20, wherein one surface of the magnet unit 2 in proximity to the acting surface A0 is first magnetic pole 21.

In order to stabilize the magnetism of the magnet unit 2, one surface of the magnet unit 2 in proximity to the acting surface A0 and the other surface thereof distal from the acting surface A0 are configured to have opposite polarities. In other words, the magnet unit 2 is divided into two layers, wherein one layer is located on the surface in proximity to the acting surface A0, and the other layer is located on the surface distal from the acting surface A0. One surface in proximity to the acting surface A0 and the other surface distal from the acting surface A0 have opposite polarities. In the present embodiment, one surface of the magnet unit 2 in proximity to the acting surface A0 is first magnetic pole 21, and the other surface distal from the acting surface A0 is second magnetic pole 22. The first magnetic pole 21 and the second magnetic pole 22 have opposite polarities.

When the wireless power transmission apparatus A2 is used in cooperation with the first wireless power receiving apparatus B1 or the first wireless power transmitting apparatus C1, the coil 1 is opposite to the wireless power receiving coil 3 or the wireless power transmitting coil 5. In this case, the magnet unit 2 slides in the accommodation body 20, such that the first magnetic pole 21 is opposite to the second magnetic pole 42 of the magnet unit 4 or the second magnetic pole 62 of the magnet unit 6. The first magnetic pole 21 and the second magnetic pole 42/62 have opposite polarities, and therefore attract each other to generate a positioning assistance effect.

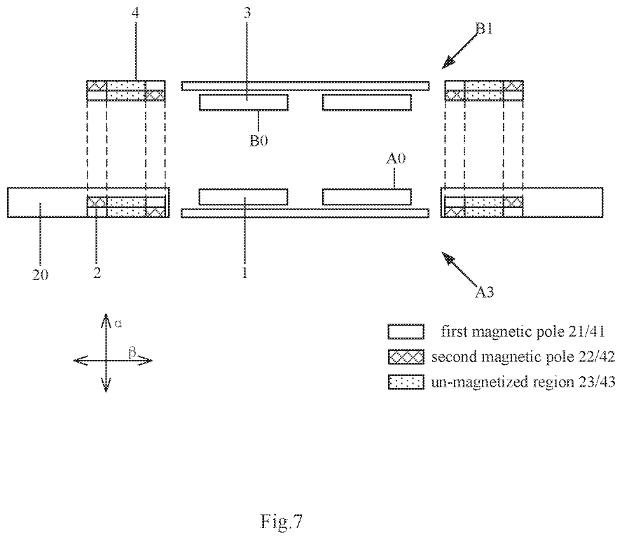

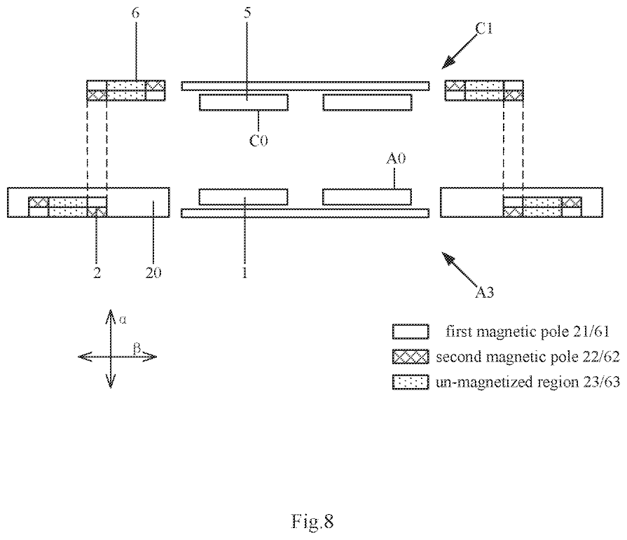

FIGS. 7 and 8 are operating schematic views of the wireless power transmission apparatus in cooperation with the first wireless power receiving apparatus and the first wireless power transmitting apparatus according to the third embodiment of the present disclosure. As shown in FIGS. 7 and 8, in the present embodiment, namely in the wireless power transmission apparatus A3, the magnet unit 2 is disposed to be slidable in a second direction f3 in the accommodation body 20, wherein on the surface of the magnet unit 2 in proximity to the acting surface A0, one end close to the coil 1 is first magnetic pole 21, the other end distal from the coil 1 is second magnetic pole 22, and the middle part is un-magnetized region 23. In other words, compared with the magnet unit 2 only having one magnetic pole in the second embodiment, the magnet unit 2 in the present embodiment has two magnetic poles at two ends, and therefore can more flexibly adapt to the external wireless power device.

The same as the second embodiment, in the wireless power transmission apparatus A3, one surface of the magnet unit 2 in proximity to the acting surface A0 and the other surface thereof distal from the acting surface A0 are also configured to have opposite polarities. In addition, due to the characteristic of the magnet, the un-magnetized region 23 between the two magnetic poles of the magnet unit 2 can be magnetized by the magnetic poles on two sides, and therefore has weak magnetism. In other words, one side of the un-magnetized region 23 close to the first magnetic pole 21 is second magnetic pole 22 with weak magnetism and opposite to the first magnetic pole 21, and the other side close to the second magnetic pole 22 is first magnetic pole 21 with weak magnetism.

When the wireless power transmission apparatus A3 is used in cooperation with the first wireless power receiving apparatus B1 or the first wireless power transmitting apparatus C1, the coil 1 is opposite to the wireless power receiving coil 3 or the wireless power transmitting coil 5. In this case, the magnet unit 2 slides in the accommodation body 20, such that the first magnetic pole 21 and the second magnetic pole 22 at the two ends of the magnet unit 2 are respectively opposite to the second magnetic pole 42 and the first magnetic pole 41 at the two ends of the magnet unit 4, or the first magnetic pole 21 of the magnet unit 2 is opposite to the second magnetic pole 62 of the magnet unit 6, so as to generate a positioning assistance effect.

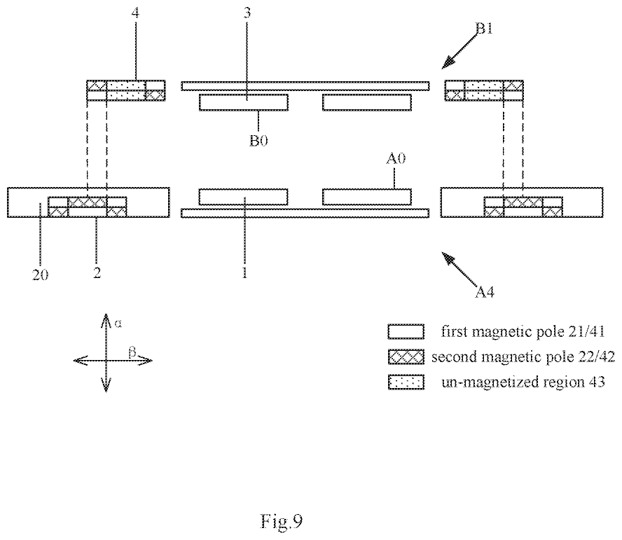

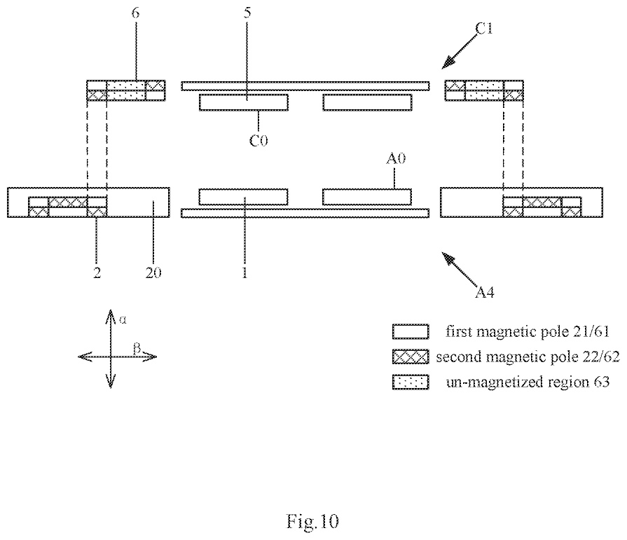

FIGS. 9 and 10 are operating schematic views of the wireless power transmission apparatus in cooperation with the first wireless power receiving apparatus and the first wireless power transmitting apparatus according to the fourth embodiment of the present disclosure. As shown in FIGS. 9 and 10, in the present embodiment, namely in the wireless power transmission apparatus A4, the magnet unit 2 is disposed to be slidable in a second direction f3 in the accommodation body 20, wherein on the surface of the magnet unit 2 in proximity to the acting surface A0, one end close to the coil 1 and the other end distal from the coil 1 are first magnetic poles 21, and second magnetic pole 22 is disposed between the two first magnetic poles 21. In other words, different from the second embodiment and the third embodiment, the wireless power transmission apparatus A4 is provided with three magnetic poles, and therefore can better adapt to various external wireless power devices with different magnet unit 4/6 arrangement sizes. The same as the second embodiment and the third embodiment, one surface of the magnet unit 2 in proximity to the acting surface A0 and the other surface thereof distal from the acting surface A0 are also configured to have opposite polarities.

When the wireless power transmission apparatus A3 is used in cooperation with the first wireless power receiving apparatus B1 or the first wireless power transmitting apparatus C1, the coil 1 is opposite to the wireless power receiving coil 3 or the wireless power transmitting coil 5. In this case, the magnet unit 2 slides in the accommodation body 20, such that the second magnetic pole 22 of the magnet unit 2 is opposite to the first magnetic pole 41 of the magnet unit 4, or the first magnetic pole 21 of the magnet unit 2 is opposite to the second magnetic pole 62 of the magnet unit 6, so as to generate a positioning assistance effect. Simultaneously, the second magnetic pole 42 with weak magnetism of the un-magnetized region 43 is opposite to the first magnetic pole 21 of the end of the magnet unit 2 in proximity to the coil 1, and have a certain magnetic attraction force therebetween.

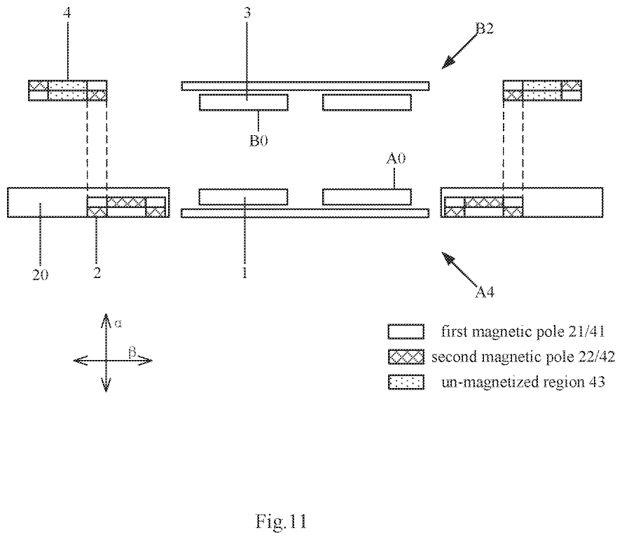

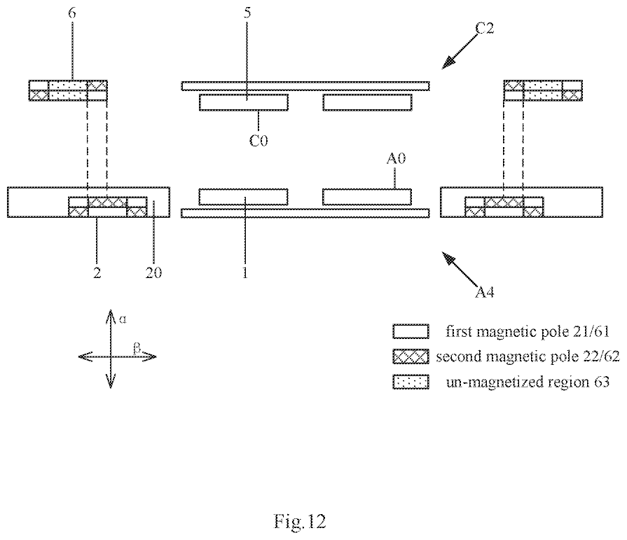

FIGS. 11 and 12 are operating schematic views of the wireless power transmission apparatus in cooperation with the second wireless power receiving apparatus and the second wireless power transmitting apparatus according to the fourth embodiment of the present disclosure. As shown in FIGS. 11 and 12, the wireless power transmission apparatus internally provided with a slidable magnet unit 2 not only can adapt to the arrangement sizes of the magnet units 4/6 in the first wireless power receiving apparatus B1 or the first wireless power transmitting apparatus C1, but also can adapt to the arrangement sizes, which are different from the arrangement sizes of the above two magnet units, of the magnet units 4/6 in the second wireless power receiving apparatus B2 or the second wireless power transmitting apparatus C2.

For example, when the wireless power transmission apparatus A4 is used in cooperation with the second wireless power receiving apparatus B2 or the second wireless power transmitting apparatus C2, the coil 1 is opposite to the wireless power receiving coil 3 or the wireless power transmitting coil 5. In this case, the magnet unit 2 slides in the accommodation body 20, such that the first magnetic pole 21 of the end of the magnet unit 2 distal from the coil 1 is opposite to the second magnetic pole 41 of the magnet unit 4, or the second magnetic pole 22 is opposite to the first magnetic pole 61 of the magnet unit 6, so as to generate a positioning assistance effect. Simultaneously, the second magnetic pole with weak magnetism of the un-magnetized region 63 is opposite to the first magnetic pole 21 of the end of the magnet unit 2 distal from the coil 1, and have a certain magnetic attraction force therebetween.

In the above four embodiments, the first magnetic pole 21 is configured to be N pole, and the second magnetic pole 22 is configured to be S pole. Optionally, the first magnetic pole 21 can also be S pole, in which case the second magnetic pole 22 be N pole. The design can change according to specific production requirements.

Further, in the above four embodiments, the magnet unit 2 has a cuboid shape; optionally, the magnet unit 2 can also have other shapes as long as the magnet unit can slide in the accommodation body 20. Optionally, the magnet unit 2 can also have other magnetic pole distributions in addition to the magnetic pole distributions in the above four embodiments.

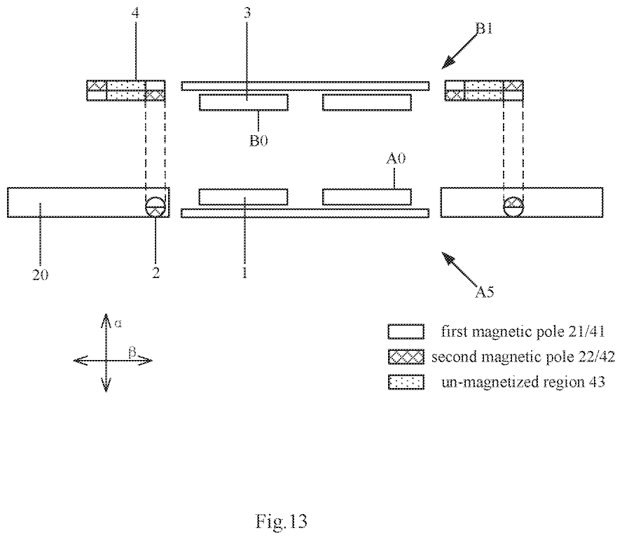

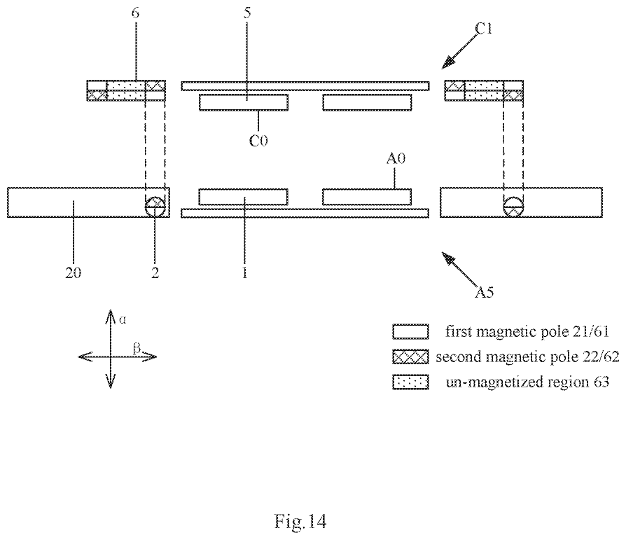

FIGS. 13 and 14 are operating schematic views of the wireless power transmission apparatus in cooperation with the first wireless power receiving apparatus and the first wireless power transmitting apparatus according to the fifth embodiment of the present disclosure. As shown in FIGS. 13 and 14, the magnet unit 2 is disposed to be rollable in a second direction f3 in the accommodation body 20, and can be used in cooperation with the external wireless power device.

In the present embodiment, namely in the wireless power transmission apparatus A5, the magnet unit 2 has a rollable shape, and is divided into two sides by a surface passing the center of it, wherein one side is first magnetic pole 21, and the other side is second magnetic pole 22. In other words, the magnet unit 2 can have a spherical shape, a cylindrical shape, a hollow cylindrical shape, and other rollable shapes; and the magnetic pole distribution is as follows: the magnet unit is divided into two parts by a surface passing the center point of the rollable body, wherein one part is the first magnetic pole 21, and the other part is the second magnetic pole 22 with an opposite polarity. For example, for a cylindrical magnet unit 2, the magnet unit can be divided into two parts by a surface passing a diameter of an end surface of the cylinder; and for a spherical magnet unit 2, the magnet unit can be divided into two parts by a surface passing the sphere center. The magnetic poles are configured in such a mode that in a rolling process of the magnet unit 2, the magnetic poles can be reversed in the first direction or the second direction; that is, at one position, the first magnetic pole 21 is in proximity to the acting surface A0, and at the same position or another position during rolling, the magnetic poles are reversed and the second magnetic pole 22 is in proximity to the acting surface A0. In addition, in order to stabilize the magnetism of the magnet unit 2, the volumes of the two magnetic poles should be basically the same.

When the wireless power transmission apparatus A5 is used in cooperation with the first wireless power receiving apparatus B1 or the first wireless power transmitting apparatus C1, the coil 1 is opposite to the wireless power receiving coil 3 or the wireless power transmitting coil 5; in this case, when the magnet unit 2 rolls in the accommodation body 20, not only can the distance between itself and the coil 1 be changed, but also the magnetic pole can be reversed. For example, when used in cooperation with the first wireless power receiving apparatus B1, on surface of the magnet unit 2 in proximity to the acting surface A0 is first magnetic pole 21, and the other surface distal from the acting surface is second magnetic pole 22; the first magnetic pole 21 is opposite to the second magnetic pole 42 which is located at the end close to the wireless power receiving coil 3 and on the surface of the magnet unit 4 of the first wireless power receiving apparatus B1 in proximity to the receiving surface B0, so as to realize an attraction effect. When used in cooperation with the first wireless power transmitting apparatus C1, the end close to the wireless power transmitting coil 5 and on the surface of the magnet unit 6 in proximity to the transmitting surface C0 is first magnetic pole 61; in this case, the magnetic poles of the magnet unit 2 are reversed at the same position; and the surface in proximity to the acting surface A0 changes to be the second magnetic pole 22 which is opposite to the first magnetic pole 61, so as to realize an attraction effect.

Further, in the present embodiment, in different accommodation bodies 20 arranged around the coil 1, the magnet units 2 can be located at different positions and form different magnetic pole attraction relationships with the magnet units 4/6. For example, when the wireless power transmission apparatus A5 is used in cooperation with the first wireless power receiving apparatus B1, accommodation body 20 at the left in the second direction (3, the magnet unit 2 is closer to the coil 1, and the first magnetic pole 21 is opposite to the second magnetic pole 42 of the magnet unit 4; and in the right accommodation body 20, the magnet unit 2 is more distal from the coil 1, and the second magnetic pole 22 is opposite to the first magnetic pole 41 of the magnet unit 4. In other words, when the magnet unit 2 is formed as a rollable body, the magnet unit 2 can be asymmetrically distributed in the accommodation body 20 owing to the magnetic pole reversal property thereof.

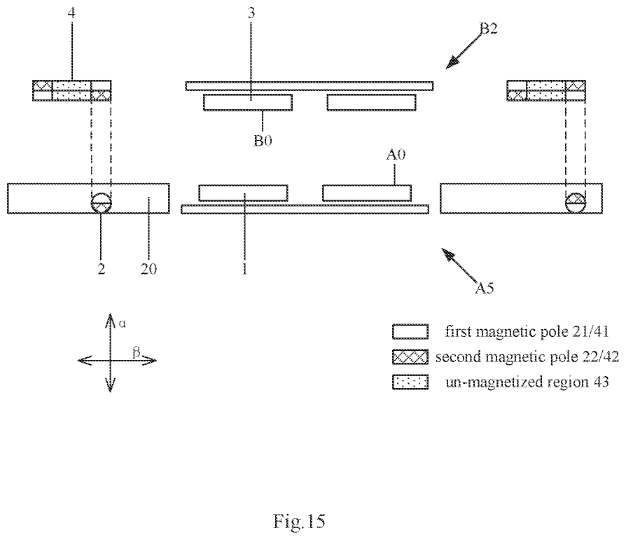

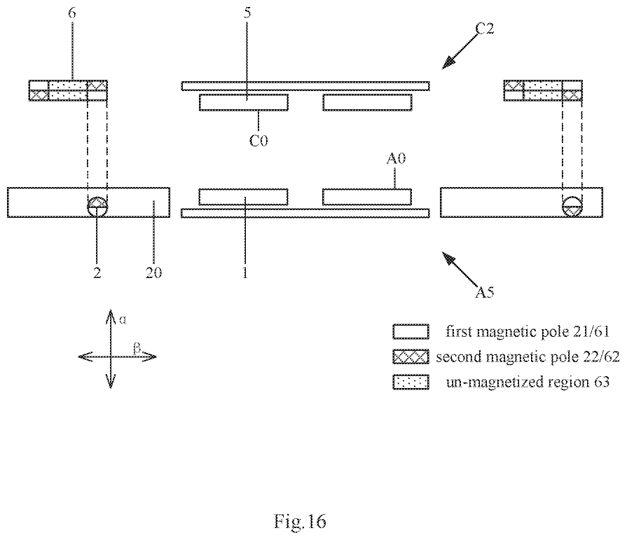

FIGS. 15 and 16 are operating schematic views of the wireless power transmission apparatus in cooperation with the second wireless power receiving apparatus and the second wireless power transmitting apparatus according to the fifth embodiment of the present disclosure. As shown in FIGS. 15 and 16, the wireless power transmission apparatus internally provided with a rollable magnet unit 2 can also adapt to the external wireless power device with the magnet units 4/6 in different arrangement sizes.

In this case, the magnet unit 2 rolls in the direction in proximity to or distal from the coil 1 while the magnetic poles are reversed, such that the first magnetic pole 21 is opposite to the second magnetic poles 42/62, or the second magnetic pole 22 is opposite to the first magnetic poles 41/61.

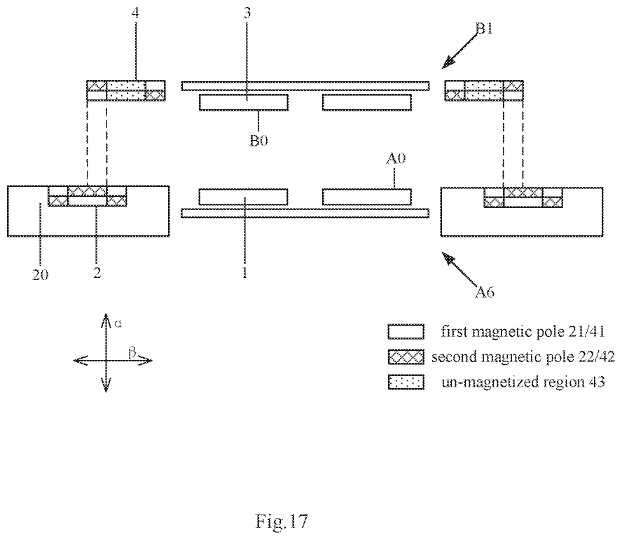

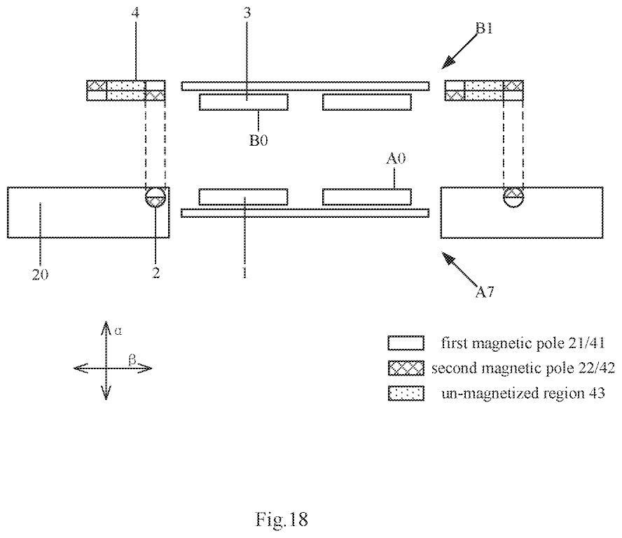

FIGS. 17 and 18 are operating schematic views of the wireless power transmission apparatus in cooperation with the first wireless power receiving apparatus according to the sixth embodiment and the seventh embodiment. As shown in FIGS. 17 and 18, the magnet unit 2 can also simultaneously move in the first direction α and the second direction β. In other words, when used in cooperation with the external wireless power device, the magnet unit 2 can move in the first direction α to get close to the acting surface A0 while rolling or sliding in the second direction β.

Taking the seventh embodiment, namely the situation that the wireless power transmission apparatus A7 is used in cooperation with the first wireless power receiving apparatus B1 as an example, the right magnet unit 2 moves rightwards while the magnetic poles are reversed, such that the second magnetic pole 22 is opposite to the first magnetic pole 21 of the magnet unit 4 at the end distal from the wireless power transmitting coil 3. Simultaneously, the magnet unit 2 moves upwards in proximity to the acting surface A0, so as to provide a greater magnetic attraction force. Optionally, the magnet unit 2 can have other magnetic pole configurations or other shapes.

It should be understood that the type and model of the external wireless power device are not limited to the above wireless power receiving apparatuses B1, B2 and wireless power transmitting apparatuses C1, C2, and the magnet units 4/6 can also have other magnetic pole distribution and arrangement positions. Therefore, the present application does not limit the corresponding relationship between the positions of the magnet unit 2 of the wireless power transmission apparatus and the magnet units 4/6 of the external wireless power device.

In the above various embodiments, the accommodation body 20 is formed as a box-like cube, so as to limit the movement direction or movement position of the magnet unit 2. In order to enable the magnet unit 2 to smoothly move in the accommodation body 20, when the magnet unit 2 is configured to move in the accommodation body 20 in the first direction α, the dimension of the accommodation body 20 in the first direction is greater than the dimension of the magnet unit 2 in the first direction, and the dimension in the second direction is basically the same as the dimension of the magnet unit 2, so as to limit the movement thereof in the second direction. For the same reasons, when the magnet unit 2 is configured to move in the accommodation body 20 in the second direction β, the dimension of the accommodation body 20 in the second direction is greater than the dimension of the magnet unit 2 in the second direction, and the dimension in the first direction is basically the same as the dimension of the magnet unit 2. When the magnet unit 2 can move in the accommodation body 20 in both the first direction α and the second direction β, the dimensions of the accommodation body 20 in the first direction and the second direction are both greater than the dimensions of the magnet unit 2 in the above two directions, so as to provide adequate movement space. Further, the accommodation body 20 can also be formed as a fence. When the magnet unit 2 only can move in one of the first direction α and the second direction β, the fence disposed in the direction can limit the movement position of the magnet unit 2. Optionally, the accommodation body 20 can also be formed in other shapes.

Further, in order to ensure that the magnet unit 2 and the magnet units 4/6 of the external wireless power device can generate a magnetic attraction force therebetween, the accommodation body 20 is made from a non-magnetic material. When the accommodation body 20 and the coil 1 are together disposed in a housing of the wireless power transmission apparatus, surface of the accommodation body 20 in proximity to the acting surface A0 should be as close as possible to the surface of the housing, so as to reduce magnetic force loss.

Further, the accommodation body 20 accommodates at least one magnet unit 2. The magnetic poles at the end of the magnet unit 2 in proximity to the coil 1 have the same polarity. In other words, the accommodation body 20 can be internally provided with a plurality of magnet units 2. In order to stabilize the performance of the wireless power transmission apparatus, according to the characteristic of the magnet, the magnetic poles at the ends of the magnet units 2 in proximity to the coil 1 should be consistent, so as to ensure the magnetic attraction efficiency. For example, all the magnetic poles are first magnetic poles 21.

Further, the magnet units 4/6 of the external wireless power device are generally arranged in a circular shape; therefore, the accommodation bodies 20 can also be arranged around the coil 1 in a circular contour, and maintain a predetermined distance to the coil 1. Optionally, the accommodation bodies 20 can also be arranged in other shapes in addition to the circular shape, for example, in a fan shape; in other words, the accommodation bodies 20 can be arranged in a part of the arc-shaped region, as long as can attract to the external wireless power device to realize the positioning assistance effect. Optionally, the number of the accommodation bodies 20 can change, and the distance between the accommodation body and the coil 1 is not limited and can change according to specific production requirements.

The wireless power transmission apparatus of the embodiment of the present disclosure includes a coil, accommodation bodies, and magnet units, wherein the accommodation bodies are arranged at intervals around the coil; and the magnet unit is disposed in the accommodation body in a movable manner. Owing to a constrained activity of the magnet unit, the wireless power transmission apparatus in the technical solution of the embodiment of the present disclosure can adapt to a plurality of wireless power receiving or transmitting apparatuses, thereby having good practicability, and improving the use experience of a user and the charging efficiency.

The descriptions above are only preferred embodiments of the present disclosure, but are not intended to limit the present disclosure. For a person skilled in the art, the present disclosure may have various changes and variations. Any modifications, equivalent substitutions, improvements and the like made within the spirit and principles of the present disclosure are all intended to be concluded in the protection scope of the present disclosure.

I/We claim:

1. A wireless power transmission apparatus, comprising:
a coil (1);
accommodation bodies (20), arranged at intervals around the coil (1); and
magnet units (2), disposed in the accommodation body (20) in a movable manner.

2. The wireless power transmission apparatus according to claim 1, wherein the magnet unit (2) is disposed to be movable in a first direction in the accommodation body (20), the first direction being in parallel with the axial direction of the coil (1).

3. The wireless power transmission apparatus according to claim 2, wherein the dimension of the accommodation body (20) in the first direction is greater than the dimension of the magnet unit (2) in the first direction.

4. The wireless power transmission apparatus according to claim 2, wherein the wireless power transmission apparatus is provided with an acting surface; surface of the accommodation body (20) distal from the acting surface is lower than surface of the coil (1) distal from the acting surface.

5. The wireless power transmission apparatus according to claim 2, wherein the magnet unit (2) is disposed to be slidable or rollable in a second direction in the accommodation body (20), the second direction being perpendicular to the axial direction of the coil (1).

6. The wireless power transmission apparatus according to claim 5, wherein the dimension of the accommodation body (20) in the second direction is greater than the dimension of the magnet unit (2) in the second direction.

7. The wireless power transmission apparatus according to claim 5, wherein the wireless power transmission apparatus is provided with an acting surface;
surface of the magnet unit (2) in proximity to the acting surface is a first magnetic pole (21); or
one end close to the coil (1) and on the surface of the magnet unit (2) in proximity to the acting surface is a first magnetic pole (21), the other end distal from the coil (1) is a second magnetic pole (22); or
one end close to the coil (1) and on the surface of the magnet unit (2) in proximity to the acting surface and the other end distal from the coil (1) are first magnetic poles (21), and a second magnetic pole (22) is disposed between the two first magnetic poles (21); and
the first magnetic pole (21) and the second magnetic pole (22) have opposite polarities.

8. The wireless power transmission apparatus according to claim 5, wherein the magnet unit (2) has a rollable shape; the magnet unit (2) is divided into two sides by a surface passing the center of the magnet unit (2); one side is a first magnetic pole (21), and the other side is a second magnetic pole (22); and
the first magnetic pole (21) and the second magnetic pole (22) have opposite polarities.

9. The wireless power transmission apparatus according to claim 1, wherein the accommodation body (20) is formed as a box; or
the accommodation body (20) is formed as a fence.

10. The wireless power transmission apparatus according to claim 5, wherein the accommodation body (20) accommodates at least one magnet unit (2).

11. The wireless power transmission apparatus according to claim 10, wherein the accommodation body (20) accommodates multiple magnet units (2), and ends of the magnet units (2) in proximity to the coil (1) have the same magnetic polarity.
